(19) United States
(12) Patent Application Publication
(10) Pub. No.: US 2022/0235940 A1
(43) Pub. Date: Jul. 28, 2022

(54) QUICKLY-REPAIRABLE PELLET GRILL

(71) Applicant: Ningbo Beijixin Technology Co., Ltd., Cixi (CN)

(72) Inventor: Xinyuan Yu, Cixi (CN)

(73) Assignee: Ningbo Beijixin Technology Co., Ltd., Cixi (CN)

(21) Appl. No.: 17/723,508

(22) Filed: Apr. 19, 2022

(30) Foreign Application Priority Data
Mar. 11, 2022 (CN) 202220540705.2

(51) Int. Cl. F24B 13/00; F23B 40/08; A47J 37/07

(52) U.S. Cl. CPC F24B 13/006; A47J 37/0786; A47J 37/0704; F23B 40/08

(57) ABSTRACT

The present disclosure provides a quickly-repairable pellet grill. The pellet grill includes a pellet grill body, wherein the pellet grill body comprises a fuel conveying and stirring mechanism, a fuel feed cabinet, a combustion furnace, and a fuel conveying channel communicated with both the fuel feed cabinet and the combustion furnace; wherein the fuel conveying and stirring mechanism includes a stirrer disposed on the fuel conveying channel, a rotation driving device, and a connection base, the connection base being detachably mounted at a mounting port of the fuel conveying channel, the rotation driving device being mounted on the connection base, the stirrer being mounted at a rotation portion of the rotation driving device, a handle being disposed on the connection base.

### TECHNICAL FIELD

The present disclosure relates to pellet grills, and in particular, relates to a quickly-repairable pellet grill.

### BACKGROUND

Pellet grills are heated by combustion of pellets. A conventional pellet grill typically includes a grill body. A combustion chamber is disposed in the grill body. A grilling grid is disposed over the combustion chamber. A feed channel is disposed at a side portion of the grill body, wherein the pellets are transported to the combustion chamber via a screw conveyor mounted at the feed channel. The pellets are combusted in the combustion chamber to generate heat, such that food on the grilling grid is well baked. However, at present, a screw conveying mechanism is fixed to the feed channel by welding or the like. As a result, the screw conveying mechanism fails to be detached for repair, and thus use of the grill is inconvenient.

### SUMMARY

The present disclosure is intended to provide a quickly-repairable pellet grill to overcome the defect in the related art. The specific structure is as follows.

The present disclosure provides a quickly-repairable pellet grill. The pellet grill includes a pellet grill body, wherein the pellet grill body includes a fuel conveying and stirring mechanism, a fuel feed cabinet, a combustion furnace, and a fuel conveying channel communicated with both the fuel feed cabinet and the combustion furnace; wherein the fuel conveying and stirring mechanism includes a stirrer disposed on the fuel conveying channel, a rotation driving device, and a connection base, the connection base being detachably mounted at a mounting port of the fuel conveying channel, the rotation driving device being mounted on the connection base, the stirrer being mounted at a rotation portion of the rotation driving device, a handle being disposed on the connection base.

Preferably, a mounting portion is disposed at each of two opposite side portions of the connection base, a through hole being opened in each of the two mounting portions; and a connection portion is disposed at each of two side portions of the mounting port of the fuel conveying channel, a threaded hole being opened in each of the two connection portions, the two threaded holes respectively corresponding to the two through holes in terms of position, a bolt being screwed into each of the two through holes, screws of the bolts being threaded-connected to the threaded holes.

Preferably, the pellet grill body further includes a cabinet and a pipe disposed in the cabinet; wherein an inner hole in the pipe serves as the fuel conveying channel, and the connection portion is disposed at an inner side end of the cabinet, an inlet port being disposed at the inner side end of the cabinet, the inlet port being interconnected to an outlet port of the fuel feed cabinet, the inlet port being interconnected to an inlet port of the fuel conveying channel via a funnel.

Preferably, the combustion furnace is disposed on the cabinet.

Preferably, a tray is mounted at the inner side end of the cabinet; wherein a positioning block is disposed on the tray, and a positioning slot is disposed in the connection base, the positioning block being correspondingly inserted into the positioning slot.

Preferably, the tray includes a horizontal disc and an inclined disc hinged to one end of the horizontal disc.

Preferably, the connection base includes a fixing frame and a base body; wherein the mounting portion is disposed on the base body, the handle is disposed on the base body, the rotation driving device is mounted on the fixing frame, and the fixing frame is mounted on the base body.

Preferably, the quickly-repairable pellet grill further includes a protection case; wherein the inner side end of the cabinet penetrates through a mounting hole in one side of the protection case, a lateral plate at the mounting hole being fixedly connected to a side wall of the cabinet, and the fuel feed cabinet is mounted into the protection case.

Preferably, the rotation driving device is a motor, and a connection pipe is disposed on the stirrer; wherein the connection pipe penetrates through a retaining ring at one port of the fuel conveying channel and is fixedly connected to a rotation shaft of the motor via a bolt, a fan being mounted at a tail end of the rotation shaft.

Preferably, a window is opened in the protection case; wherein the window corresponds to the fuel conveying and stirring mechanism in terms of position, and an area of the window is greater than the fuel conveying and stirring mechanism.

In the quickly-repairable pellet grill according to the present disclosure, the connection base is detachably mounted at the mounting port of the fuel conveying channel, such that the fuel conveying and stirring mechanism is detachable from the fuel conveying channel. In this way, a maintenance worker checks and repair the detached fuel conveying and stirring mechanism, and the stirrer may be quickly replaced, such that use of the grill is more convenient. In addition, configuration of the handle facilitates detaching of the fuel conveying and stirring mechanism. Further, when the pellet grill operates normally, configuration of the fixing frame achieves a protection and limiting effect on the motor, reduces an angle of rotation in the case of dead-lock of the motor in fuel feeding to reduce a force suffered by the screw of the rotation shaft of the motor, thereby achieving a protection effect. This structure has the advantages of use convenience and improving use experience of such products.

### BRIEF DESCRIPTION OF THE DRAWINGS

FIG. 1 is an overall schematic structural view (1);

FIG. 2 is an overall schematic structural view (2);

FIG. 3 is an exploded view (1);

FIG. 4 is an exploded view (2);

FIG. 5 is an overall schematic structural view (3); and

FIG. 6 is an overall schematic structural view (4).

### DETAILED DESCRIPTION

The technical solutions according to the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art shall fall within the protection scope of the present disclosure.

### Embodiment

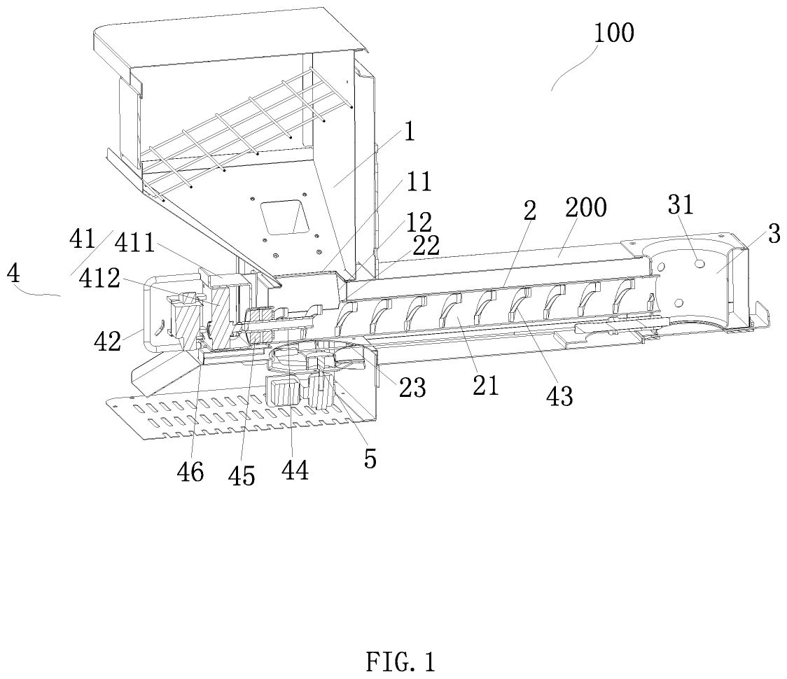

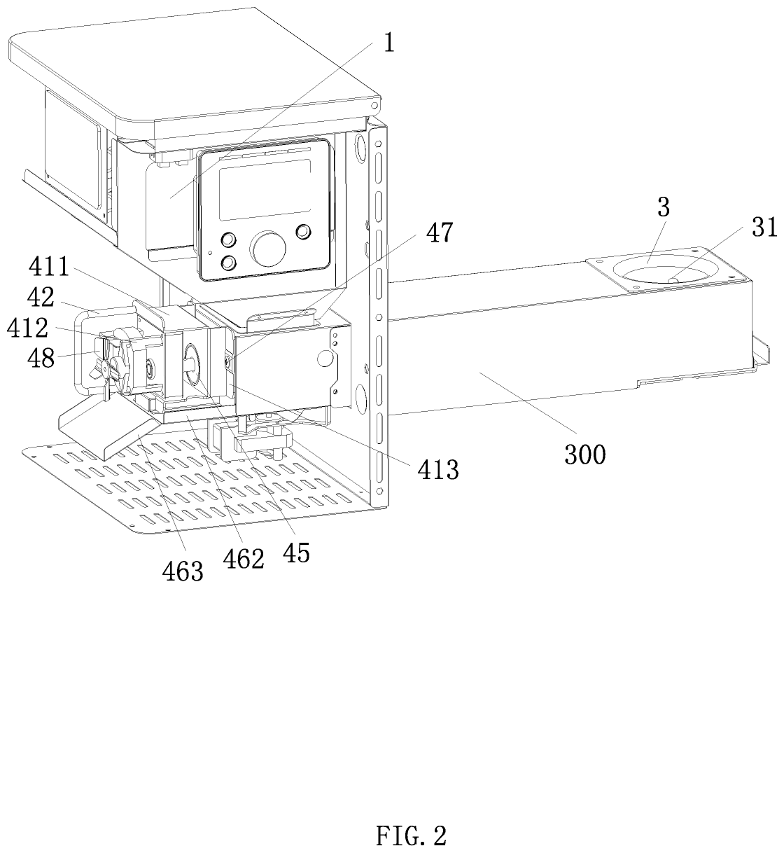

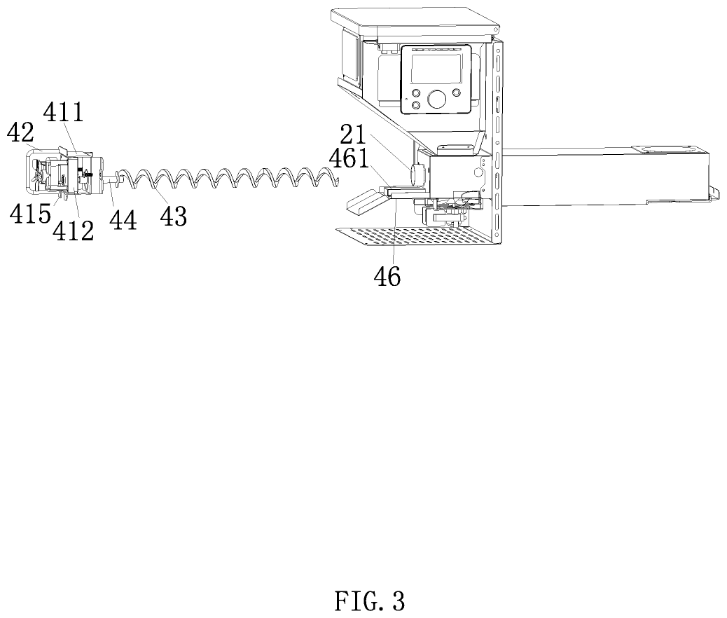

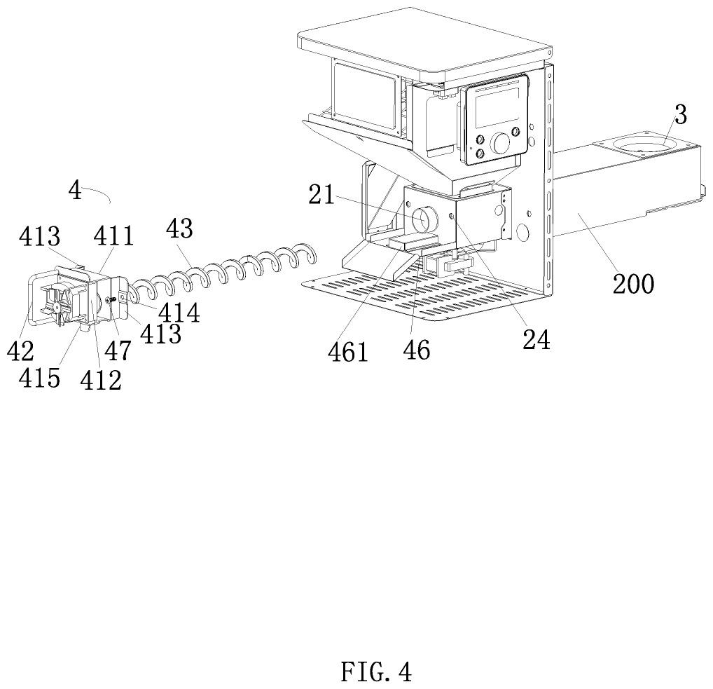

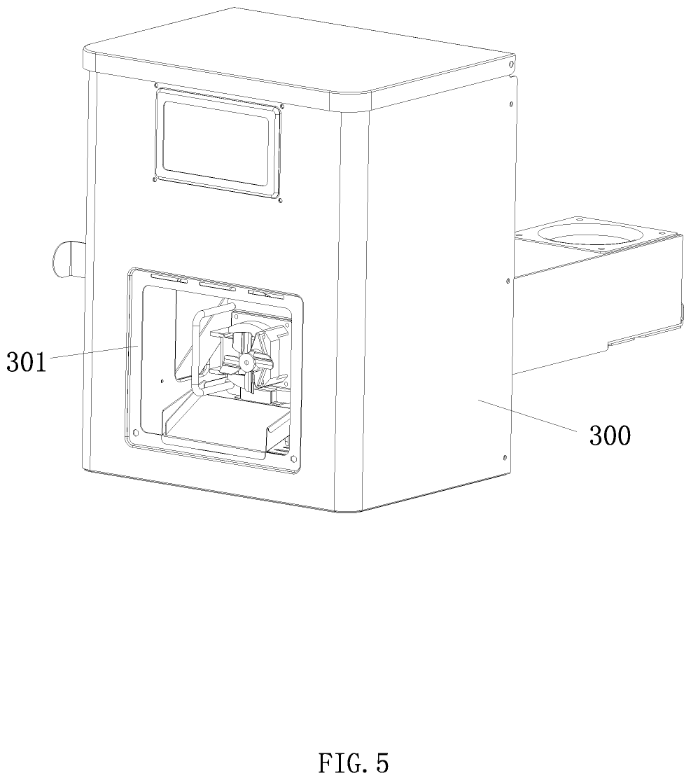

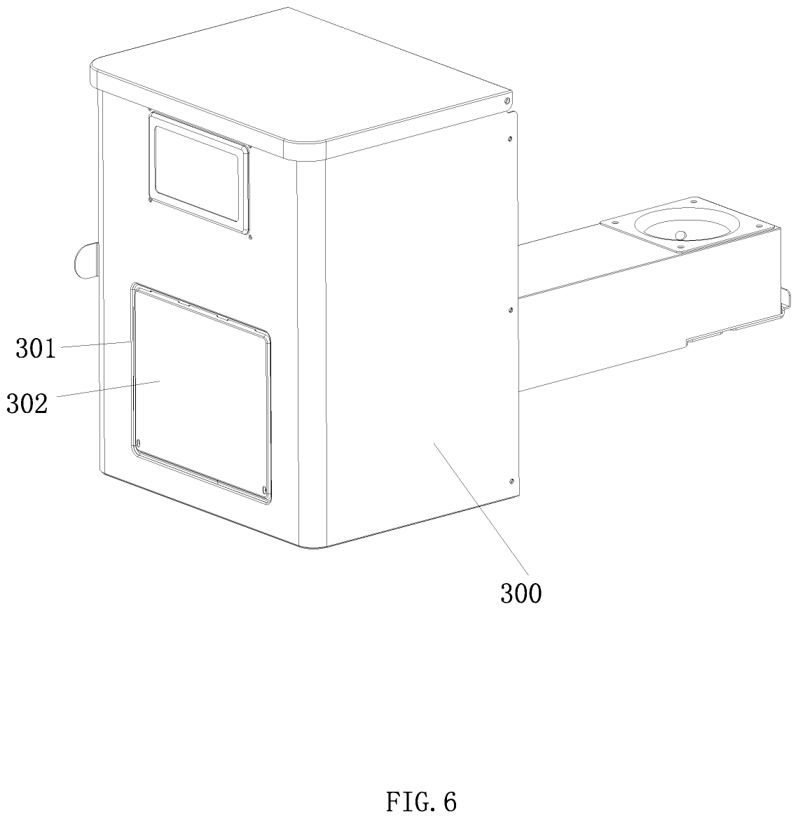

As illustrated in FIG. 1 to FIG. 6, this embodiment provides a quickly-repairable pellet grill. The pellet grill includes a pellet grill body 100. The pellet grill body 100 includes a fuel conveying and stirring mechanism 4, a fuel feed cabinet 1, a combustion furnace 3, and a fuel conveying channel 21 communicated with both the fuel feed cabinet 1 and the combustion furnace 3. The fuel conveying and stirring mechanism 4 includes a stirrer 43 disposed on the fuel conveying channel 21, a rotation driving device, and a connection base 41. The connection base 41 is detachably mounted at a mounting port of the fuel conveying channel 21. The rotation driving device is mounted on the connection base 41. The stirrer 43 is mounted at a rotation portion of the rotation driving device. A handle 42 is disposed, by a bolt 47 or by welding, on the connection base 41. The handle 42 is in a box-on-side shape. Preferably, a mounting portion 413 are disposed at each of two opposite side portions of the connection base (41). A through hole 414 is opened in each of the two mounting portions 413. A connection portion is disposed at each of two side portions of the mounting port of the fuel conveying channel 21. A threaded hole 24 is opened in each of the two connection portions. The two threaded holes 24 respectively correspond to the two through holes 414 in terms of position. The bolt 47 is screwed into each of the two through holes 414. Screws of the bolts 47 being threaded-connected to the threaded holes 24. The bolt 47 configured to fixedly connect the connection portion to the mounting portion 413 may be a butterfly bolt or a cross-head bolt or a flat-head bolt. Where detaching is desired, the bolt 47 is removed, and thus the fuel conveying and stirring mechanism 4 may be detached.

The rotation driving device is a motor, and a connection pipe 44 is disposed on the stirrer 43. The connection pipe 44 penetrates through a retaining ring 45 at one port of the fuel conveying channel 21 and is fixedly connected to a rotation shaft of the motor via a bolt. A fan 48 is mounted at a tail end of the rotation shaft. In this case, after the maintenance worker removes the bolt connecting the connection pipe 44 to the rotation shaft of the motor, the stirrer 43 may be quickly replaced. The stirrer 43 may be a screw.

Specifically, the pellet grill body 100 further includes a cabinet 200 and a pipe 2 disposed in the cabinet 200. An inner hole in the pipe 2 serves as the fuel conveying channel 21, and the connection portion is disposed at an inner side end of the cabinet 200. An inlet port 22 is disposed at the inner side end of the cabinet 200. The inlet port 22 is interconnected to an outlet port 11 of the fuel feed cabinet 1. The inlet port 22 is interconnected to an inlet port of the fuel conveying channel 21 via a funnel 12. The combustion furnace 3 is disposed on the cabinet 200. Such structural configuration is reasonable, and in addition, fuel feeding is smooth, thereby improving use effect of the pellet grill.

Preferably, a tray 46 is mounted at the inner side end of the cabinet 200. A positioning block 461 is disposed on the tray 46, and a positioning slot 415 is disposed in the connection base 41. The positioning block 461 is correspondingly inserted into the positioning slot 415. The positioning block 461 is configured to mate with the positioning slot 415, such that the fuel conveying and stirring mechanism 4 is stably positioned upon mounting. Preferably, the tray 46 includes a horizontal disc 462 and an inclined disc 463 hinged to one end of the horizontal disc 462. With such structural configuration, when the fuel conveying and stirring mechanism 4 is pulled out from the fuel conveying channel 21, receiving and fall guide are provided for the fuel unexpectedly carried out, thereby preventing the fuel from entering the protection case 300.

Preferably, a blower 5 is mounted at a vent 23 at the inner side end of the cabinet 200, and a vent hole 31 is disposed in the combustion furnace 3. By ventilation, the combustion furnace 3 has sufficient oxygen for combustion, thereby improving use performance.

Preferably, the connection base 41 includes a fixing frame 412 and a base body 411. The mounting portion 413 is disposed on the base body 411. The handle 42 is disposed on the base body 411. The rotation driving device is fixed to the fixing frame 412 by a screw 47 or by welding, and the fixing frame 412 is fixed to the base body 411 by a screw 47 or by welding. Configuration of the fixing frame 412 enables the motor to operate more stably.

Preferably, the quickly-repairable pellet grill further includes a protection case 300. The inner side end of the cabinet 200 penetrates through a mounting hole in one side of the protection case 300. A lateral plate at the mounting hole is fixedly connected to a side wall of the cabinet 200. The fuel feed cabinet 1 is mounted into the protection case 300. Such structural configuration protects the motor and the fuel feed cabinet 1.

Preferably, a window 301 is opened in the protection case 300. The window 301 corresponds to the fuel conveying and stirring mechanism 4 in terms of position, and an area of the window 301 is greater than the fuel conveying and stirring mechanism 4. A cover plate 302 is mounted over the window 301 to protect the parts inside the protection case 300.

The present disclosure is not limited to the above described embodiments, and any person could derive other various products under inspiration of the present disclosure. However, any variation in terms of shape or structure shall be considered as falling within the protection scope of the present disclosure as long as the same or similar technical solutions are employed as the present disclosure.

What is claimed is:

1. A quickly-repairable pellet grill, comprising a pellet grill body, wherein the pellet grill body comprises a fuel conveying and stirring mechanism, a fuel feed cabinet, a combustion furnace, and a fuel conveying channel communicated with both the fuel feed cabinet and the combustion furnace; wherein the fuel conveying and stirring mechanism comprises a stirrer disposed on the fuel conveying channel, a rotation driving device, and a connection base, the connection base being detachably mounted at a mounting port of the fuel conveying channel, the rotation driving device being mounted on the connection base, the stirrer being mounted at a rotation portion of the rotation driving device, a handle being disposed on the connection base.

2. The quickly-repairable pellet grill according to claim 1, wherein a mounting portion is disposed at each of two opposite side portions of the connection base, a through hole being opened in each of the two mounting portions; and a connection portion is disposed at each of two side portions of the mounting port of the fuel conveying channel, a threaded hole being opened in each of the two connection portions, the two threaded holes respectively corresponding to the two through holes in terms of position, a bolt being screwed into each of the two through holes, screws of the bolts being threaded-connected to the threaded holes.

3. The quickly-repairable pellet grill according to claim 2, wherein the pellet grill body further comprises a cabinet and a pipe disposed in the cabinet; wherein an inner hole in the pipe serves as the fuel conveying channel, and the connection portion is disposed at an inner side end of the cabinet, an inlet port being disposed at the inner side end of the cabinet, the inlet port being interconnected to an outlet port of the fuel feed cabinet, the inlet port being interconnected to an inlet port of the fuel conveying channel via a funnel.

4. The quickly-repairable pellet grill according to claim 3, wherein the combustion furnace is disposed on the cabinet.

5. The quickly-repairable pellet grill according to claim 3, wherein a tray is mounted at the inner side end of the cabinet; wherein a positioning block is disposed on the tray, and a positioning slot is disposed in the connection base, the positioning block being correspondingly inserted into the positioning slot.

6. The quickly-repairable pellet grill according to claim 5, wherein the tray comprises a horizontal disc and an inclined disc hinged to one end of the horizontal disc.

7. The quickly-repairable pellet grill according to claim 6, wherein the connection base comprises a fixing frame and a base body; wherein the mounting portion is disposed on the base body, the handle is disposed on the base body, the rotation driving device is mounted on the fixing frame, and the fixing frame is mounted on the base body.

8. The quickly-repairable pellet grill according to claim 6, further comprising a protection case; wherein the inner side end of the cabinet penetrates through a mounting hole in one side of the protection case, a lateral plate at the mounting hole being fixedly connected to a side wall of the cabinet, and the fuel feed cabinet is mounted into the protection case.

9. The quickly-repairable pellet grill according to claim 6, wherein the rotation driving device is a motor, and a connection pipe is disposed on the stirrer; wherein the connection pipe penetrates through a retaining ring at one port of the fuel conveying channel and is fixedly connected to a rotation shaft of the motor via a bolt, a fan being mounted at a tail end of the rotation shaft.

10. The quickly-repairable pellet grill according to claim 8, wherein a window is opened in the protection case; wherein the window corresponds to the fuel conveying and stirring mechanism in terms of position, and an area of the window is greater than the fuel conveying and stirring mechanism.
